(19) United States
(12) Patent Application Publication
(10) Pub. No.: US 2017/0210310 A1
(43) Pub. Date: Jul. 27, 2017

(54) ELECTRICAL CIRCUIT AND ASSOCIATED METHOD OF MANAGEMENT

(71) Applicant: Valeo Systemes de Controle Moteur, Cergy - Pontoise (FR)

(72) Inventor: Sylvain Decoster, Fontenay Le Fleury (FR)

(73) Assignee: Valeo Systemes de Controle Moteur, Cergy - Pontoise (FR)

(21) Appl. No.: 15/326,223

(22) PCT Filed: Jul. 8, 2015
(86) PCT No.: PCT/FR2015/051887

§ 371 Date: Jan. 13, 2017

(30) Foreign Application Priority Data
Jul. 16, 2014 (FR) 1456810

(51) Int. Cl. B60R 16/033; F02B 39/10; F02N 11/08; H02M 3/04

(52) U.S. Cl. CPC B60R 16/033; H02M 3/04; F02B 39/10; F02N 11/0803

(57) ABSTRACT

The present invention relates to a method for managing an electric circuit (1) of a motor vehicle, comprising:
at least one low-power component (11) requiring a minimum operating voltage,
a high-power component (13),
a power supply source (3) for the, or at least one, low-power component and for the high-power component,
the method comprising the following steps:
the voltage drop engendered by the energizing of the high-power component (13) is calculated as a function of the internal resistance of said high-power component,
the power of the high-power component (13) is limited so that the residual voltage upon the voltage drop due to the energizing of the high-power component (13) is greater than or equal to the minimum operating voltage of the, at least one, low-power component (11).

The present invention relates to the field of electrical power supply circuits, in particular for motor vehicles.

In particular, the present invention relates to electric power supply circuits comprising a power supply source intended to energize low-power components on the one hand and a high-power component on a temporary basis on the other hand. The problem with this type of electrical circuit lies in the fact that during transitional phases, energizing the high-power component causes a voltage drop in the power supply source, generally a battery. Due to this voltage drop, the other components, i.e., the other low-power components, can no longer be supplied with sufficient voltage to work properly, such that the activation of the high-power component can cause a malfunction, or even the extinction, of the low-power components.

Yet in the case of a motor vehicle electrical circuit, the low-power components powered by the battery may be elements related to safety, such as headlights, or comfort, such as a car stereo, such that their operation may cause very harmful effects with respect to the user.

It therefore appears necessary to find a solution to overcome the drawbacks of the state of the art in the case of a circuit comprising a single power supply source.

The aim of the present invention is therefore to provide a method and a piece of equipment making it possible to supply power to low-power components when a high-power component is activated.

The present invention therefore relates to a method for managing an electric circuit of a motor vehicle, comprising:
at least one low-power component requiring a minimum operating voltage,
a high-power component,
a power supply source for the, or at least one, low-power component and for the high-power component,

the method comprising the following steps:
the voltage drop engendered by the energizing of the high-power component is calculated as a function of the internal resistance of the power supply source,
the power of the high-power component is limited so that the residual voltage upon the voltage drop due to the energizing of the high-power component is greater than or equal to the minimum operating voltage of the, at least one, low-power component.

According to another aspect of the present invention, the high-power component is an electrical supercharging compressor used in a transitional phase of the motor vehicle to contribute extra power to the engine. Alternatively, the high-power component is a stop & start device.

According to an additional aspect of the present invention, the method comprises an additional preliminary step in which the internal resistance of the power supply source is determined, in particular using a sensor configured to measure the voltage and/or intensity delivered by the power supply source.

According to an additional aspect of the present invention, the determination of the internal resistance of the power supply source is done each time the motor vehicle is started.

According to another aspect of the present invention, the power supply source is a battery.

According to an additional aspect of the present invention, the, at least one, low-power component is comprised in the following list:
motor vehicle headlights,
a car stereo,
an onboard computer,
an airbag computer,
a braking system,
a multimedia system,
a navigation device,
a power steering device.

According to another aspect of the present invention, the method comprises protection for at least one second low-power component protected by a DC/DC converter arranged between the power supply source and said, at least one, second low-power component.

According to one aspect of the present invention, the limitation of the power of the high-power component comprises resetting the power of the high-power component. In other words, the high-power component is inhibited and therefore does not work.

According to another aspect of the present invention, in limiting the power of the high-power component, the power of the high-power component is made equal to a non-zero value P, in particular below a rated operating value of the high-power component.

The present invention also relates to an electrical circuit comprising:
at least one first low-power component requiring a minimum operating voltage,
a high-power component,
a power supply source for the, at least one, low-power component and the high-power component,
processing means configured to:
   calculate the voltage drop engendered by the energizing of the high-power component based on the internal resistance of said high-power component,
   limit the power of the high-power component such that the residual voltage upon the voltage drop due to the energizing of the high-power component is greater than or equal to the minimum operating voltage of the, at least one, low-power component.

According to another aspect of the present invention, the electrical circuit also comprises at least one sensor measuring the intensity and/or the voltage delivered by the power supply source.

According to an additional aspect of the present invention, the electrical circuit also comprises a DC/DC converter arranged between the power supply source and at least one second low-power component, the processing means being configured to limit the power of the high-power component such that the residual voltage upon the voltage drop due to the energizing of the high-power component is greater than or equal to the minimum operating voltage of the, at least one, first low-power component.

According to an additional aspect of the present invention, the electrical circuit is installed in a motor vehicle and the, at least one, second component corresponds to a safety-related component of the vehicle.

The electrical circuit according to the invention may comprise any one of the features described for the method that are compatible therewith.

Other features and advantages of the invention will appear in the description provided below, in reference to the appended drawings, which show possible embodiments, for information and non-limitingly.

In these drawings:

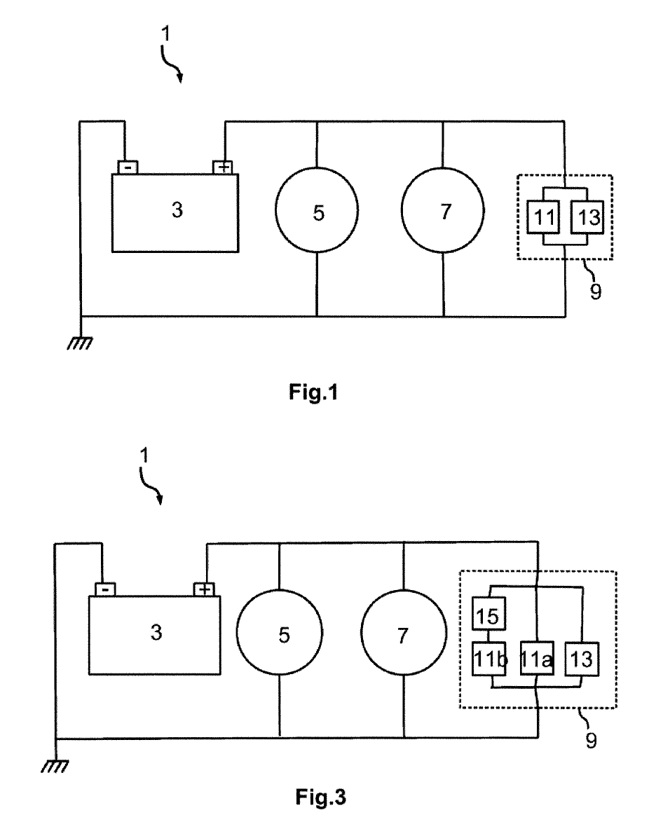

FIG. 1 shows a diagram of the electrical power supply circuit according to a first embodiment of the present invention;

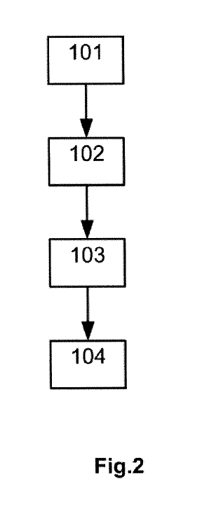

FIG. 2 shows a flowchart of the different steps of the method for managing the electrical power circuit according to the present invention;

FIG. 3 shows a diagram of an electrical power circuit according to a second embodiment of the present invention.

In the figures, the same reference numbers designate identical elements.

In the following description, the terms below are defined as follows:

The term “low-power component” corresponds to a component whose power does not exceed 1 kW.

The term “high-power component” corresponds to a component whose power exceeds 1 kW.

The term “electrical supercharging compressor” corresponds to an electrical compressor acting in addition to or in place of the turbocompressor of an engine of a motor vehicle to provide extra power, for example to erase the response time of the turbocompressor, during transitional phases, for example during low-rating accelerations.

The term “DC” corresponds to the acronym Direct Current.

The term “ASIC” corresponds to the acronym Application Specific Integrated Circuit.

The term “FPGA” corresponds to the acronym Field Programmable Gate Array.

The term “RAM” corresponds to the acronym Random Access Memory.

The term “ROM” corresponds to the acronym Read-Only Memory.

FIG. 1 shows an example architecture of an electrical power supply circuit 1 of a motor vehicle comprising a power supply source, for example a 12 or 14 V battery 3, a generator or alternator 5, a starter 7 and charges 9. The various elements of the circuit are connected in parallel on the battery 3 between a positive terminal denoted + and a negative terminal denoted − connected to the ground of the vehicle. The charges 9 comprise at least one low-power component 11, for example the headlights, the car stereo, an onboard computer or the windshield wipers, and a high-power component 13 whose power is configurable, for example an electrical supercharging compressor or a stop & start device.

As previously described, activating the high-power component 13 creates an inrush current and causes a voltage drop at the battery 3. The idea of the present invention is therefore to limit the inrush current created by the high-power component 13 by modulating its power such that the voltage drop experienced by the low-power components 11 does not disrupt their operation.

Yet the voltage drop experienced by the low-power components 11 does not depend solely on the current inrush created by activating the high-power component 13, but also the internal resistance of the battery 3, a parameter that varies over time. This parameter should therefore be used to determine the maximum authorized power of the high-power component 13 in order to guarantee the proper operation of the low-power components.

The various steps of the method for managing an electrical circuit as shown in FIG. 1 will now be described using FIG. 2.

The first step 101 corresponds to the determination of the internal resistance of the battery 3. This step may be optional, since it is not necessary to determine the internal resistance each time the electrical supercharging compressor 13 is activated. This determination of the internal resistance of the battery 3 is for example done upon each startup or at regular time intervals, for example once per week or once per month or based on a predefined schedule, the measurements for example being closer in time as the battery 3 ages. The resistance is determined from the measurement of the intensity and voltage delivered by the battery 3, for example when the vehicle is started up. This determination is for example done by a sensor combining an ammeter connected in series on the positive terminal + or negative terminal (−) and a voltmeter connected in parallel on the terminals of the battery 3. The internal resistance of the battery 3 is obtained by the relationship Ri=U/I, where Ri is the internal resistance of the battery 3, U is the voltage measured across the terminals of the battery 3, and I is the intensity measured at the output of the battery 3.

The second step 102 corresponds to the determination of the minimum voltage for the proper operation of the low-power components 11. This step is also optional, since the minimum voltage value is generally provided by the builder or can be determined beforehand through tests. This minimum voltage is generally comprised between 6 and 8 V, but can also be lower, for example between 0.5 and 2 V. Thus, for a minimum voltage of 8 V and for a 14 V battery, the voltage drop when the high-power component 13 is activated must not exceed 14−8=6 V.

The third step 103 corresponds to the calculation of the voltage drop engendered by the energizing of the high-power component 13 based on the internal resistance Ri of the battery 3 to obtain a sufficient voltage for the proper operation of the low-power components 11. Knowing the internal resistance Ri of the battery 13, which is known or determined during the first step 101, as well as the maximum acceptable voltage drop for the low-power components 11, which is known or determined during the second step 102, the maximum acceptable inrush current upon activation of the high-power component 13 can be determined by the relationship Iₘₐₓ=ΔU/Ri, where Iₘₐₓ is the maximum inrush current, ΔU is the maximum acceptable voltage drop, and Ri is the internal resistance of the battery 13.

The fourth step 104 relates to the limitation of the power of the high-power component 13 to limit the value of the inrush current to Iₘₐₓ, such that the residual voltage when the voltage drop due to the energizing of the high-power component 13 occurs is greater than or equal to the minimum operating voltage of the low-power components 11. Indeed, the power and the inrush current are directly related by the formula P=RIₘₐₓ² or P=U*Iₘₐₓ, where R is the internal resistance of the high-power component 13, P is the power of the high-power component, Iₘₐₓ is the maximum inrush current and U is the voltage. Thus, a command control loop of the power can be introduced to limit the power delivered by the high-power component 13 at each moment so as not to exceed a maximum inrush current.

According to one alternative, the limitation of the power of the high-power component 13 comprises resetting its power. In other words, the high-power component 13 is inhibited and therefore does not work. This is particularly advantageous if the battery 3 is too worn out to support the activation of the high-power component 13 without deteriorating the voltage delivered to the low-power components 11.

According to another alternative, the power of the high-power component 13 is made equal to a non-zero value P. This non-zero value P is in particular below a rated operating value of the high-power component 13. Thus, the power consumed by the high-power component 13 remains small enough to allow the minimum operating voltage of the low-power components 11 to be respected.

The various steps described above are implemented by processing means that can be centralized or distributed in different locations of the electrical control circuit. These processing means are for example logic components of the ASIC or FPGA type, a microcontroller or microprocessor, or a combination of these elements. Furthermore, these processing means can be coupled with means for storing instructions or values, for example random-access (RAM) or read-only (ROM) memories.

According to an alternative embodiment shown in FIG. 3, the electrical power supply circuit 1 of a motor vehicle differs from the circuit of FIG. 1 in that the low-power components are distributed in a first 11a and second 11b group and the electrical circuit 1 also comprises a DC/DC direct voltage converter 15 placed between the battery 3 and at least one second low-power component and corresponding to the second group 11b. Indeed, it may be necessary to protect certain low-power components 11b more effectively, for example the safety-related component(s), such that their energizing is provided by a voltage converter 15 that makes it possible, in case of voltage drop caused by the energizing of the high-power component 13, to provide a minimum power supply voltage for the second components 11b. Such a configuration makes it possible to provide an additional guarantee regarding the operation of the second components 11b in case of voltage drop. Furthermore, the number of second low-power components will be limited so as to limit the consumption necessary for the DC/DC direct voltage converter 15. The various steps of the method can then be established based on the minimum voltage necessary for the first low-power components 11a.

The present invention therefore makes it possible, due to the determination of the internal resistance of the battery 3 and the limitation of the power of the high-power component 13 during transitional phases based on the internal resistance of the battery 3, to maintain a minimum voltage for the low-power components 11 when the high-power component 13 is activated and to thus ensure the proper operation of the low-power components 11 used for safety or comfort. In the case of an electrical supercharging compressor, the power gain provided by the activation of the electrical supercharging compressor is slightly lower, but makes it possible to keep all of the other functions of the vehicle working, such as illuminating the headlights or running the car stereo. The slight power deficit is imperceptible for the user, unlike the malfunction of one of the functions related to the low-power components. The overall comfort of the vehicle is therefore improved.

1. A method for managing an electric circuit of a motor vehicle, comprising at least one low-power component requiring a minimum operating voltage, at least one high-power component, and a power supply source for the at least one low-power component and for the high-power component, the method comprising:
calculating a voltage drop engendered by the energizing of the high-power component as a function of the internal resistance of the power supply source; and
limiting the power of the high-power component so that a residual voltage upon the voltage drop due to the energizing of the high-power component is greater than or equal to the minimum operating voltage of the at least one low-power component.

2. The management method according to claim 1, wherein the high-power component is one selected from a group consisting of: an electrical supercharging compressor used in a transitional phase of the motor vehicle to contribute extra power to the engine, and a stop & start device.

3. The management method according to claim 1, further comprising a preliminary step of determining the internal resistance of the power supply source.

4. The management method according to claim 3, wherein the determination of the internal resistance of the power supply source is done each time the motor vehicle is started.

5. The management method according to claim 1, wherein the power supply source is a battery.

6. The method according to claim 1 where the at least one low-power component is one selected from a group consisting of:
an airbag computer, a braking system, a multimedia system, a navigation device, a power steering device, an onboard computer, a car stereo, and motor vehicle headlights.

7. The method according to claim 1, comprising protection for at least one second low-power component protected by a DC/DC converter arranged between the power supply source and said at least one second low-power component.

8. The method according to claim 1, wherein the limitation of the power of the high-power component comprises resetting the power of the high-power component.

9. The method according to claim 1, wherein, in limiting the power of the high-power component, the power of the high-power component is made equal to a non-zero value.

10. An electrical circuit, comprising:
at least one first low-power component requiring a minimum operating voltage;
a high-power component;
a power supply source for the at least one low-power component and the high-power component; and
processing means configured to:
calculate a voltage drop engendered by the energizing of the high-power component based on an internal resistance of said high-power component, and
limit the power of the high-power component such that a residual voltage upon the voltage drop due to the energizing of the high-power component is greater than or equal to the minimum operating voltage of the at least one low-power component.

11. The electrical circuit according to claim 10, further comprising at least one sensor measuring the intensity and/or the voltage delivered by the power supply source.

12. The electrical circuit according to claim 10, further comprising a DC/DC converter arranged between the power supply source and at least one second low-power component, the processing means being configured to limit the power of the high-power component such that the residual voltage upon the voltage drop due to the energizing of the high-power component is greater than or equal to the minimum operating voltage of the at least one first low-power component.

13. The electrical circuit according to claim 12, installed in a motor vehicle and wherein the at least one second component corresponds to a safety-related component of the vehicle.
